(19) United States
(12) Patent Application Publication
(10) Pub. No.: US 2015/0194002 A1
(43) Pub. Date: Jul. 9, 2015

(54) HUB-BASED ELECTRONIC LOCK SYSTEMS AND DEVICES

(71) Applicant: CompX International Inc., Greenville, SC (US)

(72) Inventors: Kenneth A. Kaczmarz, LaGrange Park, IL (US); John B. Payson, Morris, IL (US); Mitchell S. Mlynarczyk, Wauconda, IL (US); Brock E. Robinson, Crest Hill, IL (US); John A. Garlisch, Keeneyville, IL (US); Michael Jensen, Salem, WI (US); Jesse Mavromatis, Palatine, IL (US); Arkady Grenader, Buffalo Grove, IL (US)

(73) Assignee: CompX International Inc., Greenville, SC (US)

(21) Appl. No.: 14/591,176

(22) Filed: Jan. 7, 2015

Related U.S. Application Data
(60) Provisional application No. 61/924,319, filed on Jan. 7, 2014.

(51) Int. Cl. G07C 9/00; G06F 3/0484

(52) U.S. Cl. CPC G07C 9/00174; G06F 3/04842

(57) ABSTRACT

Hub-based electronic lock systems and devices relate to lock or access control systems, and more particularly to electronically controlled lock systems such as may be applied to various storage enclosures or cabinets to provide secure storage of various items, equipment, materials, and/or information within the enclosures or cabinets. Certain present aspects may relate to hub and/or daisy-chained control for a plurality of electronic locks used in an electronic access control system, for inventory management using electronic locks, and/or to electronic locks with various features including display screens, access controls and tracking, and alert capabilities.

### PRIORITY CLAIM

This application claims the benefit of previously filed U.S. Provisional Patent Application entitled “HUB-BASED ELECTRONIC LOCK SYSTEMS AND DEVICES,” assigned U.S. Ser. No. 61/924,319, filed Jan. 7, 2014, and which is incorporated herein by reference for all purposes.

### FIELD OF THE SUBJECT MATTER

The presently disclosed subject matter relates to locks. More particularly, the presently disclosed subject matter relates to electronic locks and related systems, and corresponding and/or related methodologies.

### BACKGROUND OF THE SUBJECT MATTER

Generally speaking, the use of various lock structures is well known in a number of different environments, for a large variety of items for which various forms of protection (i.e., physical security) is desired. Locks of many different types have been in existence for hundreds of years. Unfortunately, for just as long a period of time, there have been individuals who have sought to illicitly gain access to the protected item or area for which or on which the lock was installed. Many occasions arise that require electronic access control of different types of cabinets, entryway doors, carts, tool boxes, and other types of boxes, hereafter regardless generally of their compositions, materials, or configurations collectively referred to as an enclosure or cabinet. Such enclosures or cabinets may be provided with doors and/or may also include drawers.

The need for access control usually arises from the lack of sufficient security often provided by typical lock and key mechanisms. For example, a mechanical key may be lost or stolen. Once such a lost or stolen key has been surreptitiously obtained by an unauthorized individual, such individual in possession of such key may easily access the secured enclosure to either steal its contents or, as in the case of secured medical records or other confidential documents, view its contents. Further, when such enclosures or cabinets are accessed, there is typically no record that it has been accessed, let alone who accessed it or when such access took place.

Such shortcomings of keyed mechanical locks have contributed to the creation of the specialized field of electronic access control.

Typically, electronic access control may correspond to a three part system, including, for example: (1) a credential reader, (2) a microprocessor based control circuit, and (3) an electronic latch to mechanically open or unlock the enclosure being secured by the access control system.

Credential readers may include, but are not limited to: keypads, magnetic stripe card readers, proximity card readers, “ibuttons,” smart card readers, and/or bar code card readers. More recently, there has been progress in the field of biometrics resulting in the ability to reliably read and discern an individual's fingerprints, handprints, and retina and/or facial features.

Generally speaking, credential and/or biometric readers convert their applicable credential or biometric features, respectively, into a binary number or digital code. A microprocessor based system then reads and analyzes such binary number or digital code. Such systems are typically either standalone (attached to the reader) or networked (attached to many readers). Typically, they may read the binary number that corresponds to the potential entrant's credential or biometric features and compare it to a list of pre-approved binary numbers. In such fashion, the microprocessor based system determines if the potential entrant has the right to access the enclosure or cabinet being secured by the access control system.

If the microprocessor based system determines that the subject credential or biometric feature under consideration is valid, access is granted to the enclosure. Typically, such is accomplished by the microprocessor turning on an electronic control circuit corresponding to solid state devices or relays which in turn provide a useable electrical voltage to open an electronic latch mechanism.

There are generally speaking various types of electronic latch mechanisms, such as slam latches or dead bolt latches. Typically, dead bolt latches may utilize a fixed dead bolt without means of a spring return. Such types of latches instead make use of an electronic control circuit to actuate a motor or solenoid such as to alternately retract and/or extend a dead bolt in order to provide the locking (or unlocking) action. In other words, a locking action is typically not “automatic” when the enclosure door is closed.

The prime mover in some types of latches may typically either be a solenoid or a motor/gear train combination. Solenoid based latches having equal strength to a given motor/gear train based latch are often significantly larger and heavier than such “equivalent” motor/gear train design.

Latches constructed in accordance with the presently disclosed subject matter are in many instances preferably motor based. A representative example of such a latch is shown by the commonly owned U.S. Pat. No. 8,403,376 or a simple electronically controlled solenoid based latch may be used.

U.S. Pat. No. 7,768,378 discloses apparatus and methodology for providing a retrofittable lock assembly. The retrofittable lock contains electronic circuitry that maintains a record of user identification, date, and time of access of users seeking access to items stored in the enclosure.

U.S. Pat. No. 8,199,019 discloses apparatus and methodology for temperature monitoring and controlled access to refrigerated medications. An electronically controlled lock is installed on a refrigerator used for storage of temperature sensitive medications. Lock access is given to individuals having differing levels of access authorization so that user level authorization holders may have access to stored medications.

U.S. Patent Application Publication No. 20110012709 discloses apparatus and methodology for data control in an electronic access control system. A plurality of electronic locks are connected to a central server over a network such as an 802.11 WiFi wireless network that may be used to provide data updates and management for the individual electronic locks. To address power management problems associated with electronic locks having the capability to communicate over an 802.11 WiFi network, method and apparatus are provided for selectively powering on and off an 802.11 WiFi communications module integrated into the electronic lock to conserve power resources. An electronic access control system allows efficient data exchange between a central server and a plurality of electronic locks using a database structure, and allows for multiple simultaneous database manipulations.

U.S. Pat. No. 8,742,889 discloses apparatus and methodology for providing electronic access control, including use of a retrofittable electronic lock to provide secure storage to an enclosure. A user interface and LCD visual display permit adjustment of system operational parameters. In certain embodiments, the electronic access control system includes master-slave control capabilities and/or inventory management capability. Secure storage of the enclosure is provided when the enclosure is being moved or otherwise transported from one location to another location. Various alternative arrangements provide various alert features, as well as battery features which facilitate their rapid replacement and/or reconfiguration.

The foregoing patent related publications, all commonly owned with the subject application, are hereby fully incorporated by reference herein for all purposes.

Generally speaking, it would be desirable to have use of an electronic lock system which provided a number of hub-based electronic lock control features, for expanding the ability to electronically control electronic lock components. Further, it would be desirable to provide such a hub-based system with additional features, such as audit trail capabilities, where for each lock or latch, the hub-based system would be able to monitor, report, and log when each latch or lock opens/closes and when each associate door switch opens/closes. Still further, it would be desirable to provide a hub-based system which has the ability to independently control a number of latches though through use of a single user interface. With such an arrangement, a user would be able to operate/open a plurality of latches from the one interface, without needing to relocate and manipulate a plurality of respective displays. At the same time, it would be desirable with such an arrangement to still provide for selective programming of a single lock instead of having to identically program all locks at the same time.

While various implementations of electronic lock mechanisms and systems have been developed, no design has emerged that generally encompasses all of the desired characteristics as hereafter presented in accordance with the subject technology.

### SUMMARY OF THE SUBJECT MATTER

In view of the recognized features encountered in the prior art and addressed by the presently disclosed subject matter, improved apparatus and methodology are provided for expanding existing electronic lock control systems for operation in a hub-based environment. More particularly, improved apparatus and methodology are provided for operation in a hub-based environment but also providing additional control features, such as audit trail features. Other control features may for some embodiments relate to management of power resources such as battery resources.

The presently disclosed subject matter generally relates to lock or access control systems, and more particularly to electronically controlled lock systems such as may be applied to various storage enclosures or cabinets to provide secure storage of various items, equipment, materials, and/or information within the enclosures or cabinets. More specifically, certain present aspects may relate to hub and/or daisy-chained control for a plurality of electronic locks used in an electronic access control system, for inventory management using electronic locks, and/or to electronic locks with various features including display screens, access controls and tracking, and alert capabilities. In other present aspects, the presently disclosed subject matter provides for the ability to use a single interface as opposed to many, to set up and operate either of a single or many locks.

One such exemplary embodiment relates to a hub-based electronic lock access control system for use with a plurality of storage enclosures of the type having respectively at least an exterior portion and a securable interior portion for secure storage. Such a system preferably has a microprocessor based access control circuit having a hub output for providing control data for respective locks; a connection hub, having an input for receiving control data from such control circuit, and having a plurality of respective control outputs for providing respective control signals to respective associated electronic locks responsive thereto; a plurality of respective electronic locks associated with such connection hub and respective storage enclosures, such electronic locks configured to be unlocked by such access control circuit via such connection hub; and memory, associated with such access control circuit, for storage of data associated with access control circuit activity and with contents of an associated storage enclosure.

In certain of such systems, the connection hub may include a hub output for providing control signals via such connection hub from such control circuit to another connection hub in a daisy-chained configuration therewith. In other of such arrangements, the exemplary system may further comprise a plurality of such connection hubs in a daisy-chained configuration, for controlling a plurality of electronic locks respectively associated therewith, all controlled by such access control circuit via such plurality of connection hubs. In yet other alternatives of the foregoing, each of such connection hubs may respectively include a hub identification switch for selection of an identification position of the respective hub in a daisy-chained configuration.

In still other present variations, the foregoing exemplary control circuit may control operational power to such respective locks via such connection hub.

Other present alternatives involve systems further comprising a user interface configured to provide a user access to such access control circuit through input data verified by such microprocessor, wherein such access control circuit is configured to unlock such locks based on input data verified by such microprocessor. In still others, such user interface may be further configured to provide a user access to such memory for selective input of preprogrammed codes reflecting either of removal or addition of securely stored contents of the storage enclosures for updating of data in such memory, for coded tracking of stored contents in an enclosure, whereby a user with verified input data can obtain both access control circuit activity data and updated stored contents data from such memory for reporting on a given associated enclosure. For some such systems, a user with verified input data may be able to access and name selected of such electronic locks.

For other present variations, a hub-based electronic lock access control system may further include a plurality of communications modules respectively associated with each of such plurality of electronic locks and communicating over a network including connections which are one of hardwired and wireless connections.

In others thereof, such microprocessor based access control circuit and such connection hub respectively may have power inputs for connection to respective battery power sources. In certain of those alternatives, the hub-based electronic lock access control system may further include respective battery power sources connected with such respective connection hubs, wherein such connection hubs are configured for sharing battery power from such battery power sources, for respectively providing operational power to selected electronic locks being controlled thereby. In yet other present alternatives, a present system may be further configured for controlling such respective battery power sources connected with such respective connection hubs, so that the level of operational power from such battery power sources to selected electronic locks is controlled.

In others, such microprocessor based access control circuit may comprise a main control box having a hub-supporting circuit board in an expansion port thereof.

In some of such alternatives, such microprocessor based access control circuit may be configured for determining operational characteristics of the electronic locks associated with the hub-based electronic lock access control system.

Yet other present variations may further include at least one sensor associated with at least one of such electronic locks for providing feedback to the associated hub on operation of such associated at least one electronic lock.

For others, such microprocessor based access control circuit may be configured for operation per a user-determined mode of operation for simultaneously operating all of the electronic locks associated with the hub-based electronic lock access control system or for individually operating such electronic locks.

Yet another present exemplary embodiment may relate to a connection hub for use in a hub-based electronic lock access control system for control of a plurality of storage enclosures. Preferably, such an exemplary connection hub may comprise an input for receiving control data thereto from a control circuit; a plurality of respective control outputs for providing respective control signals to respective associated electronic locks responsive thereto; and a power input for alternative connection of such connection hub to a battery power source.

In some such exemplary embodiments, such connection hub may further include a hub output for providing control signals via such connection hub from the control circuit to another connection hub in a daisy-chained configuration therewith. In yet others, the embodiment may further comprise a plurality of such connection hubs in a daisy-chained configuration, for controlling a plurality of electronic locks respectively associated therewith, all controlled by an access control circuit via such plurality of connection hubs. For others, each of such connection hubs may respectively include a hub identification switch for selection of an identification position of the respective hub in a daisy-chained configuration.

Yet other present variations may relate to an exemplary such connection hub further including respective battery power sources connected with each of such respective connection hubs, wherein such connection hubs are configured for sharing battery power from such battery power sources, for respectively providing operational power to selected electronic locks being controlled thereby.

In others thereof, such alternative connection hub embodiments may be configured for supplying operational power to respective associated locks.

In still other variations, a present exemplary connection hub may further include at least one sensor input thereto, associated with at least one associated electronic lock for providing feedback to such connection hub on operation of such associated at least one electronic lock.

In certain broader aspects, various presently disclosed exemplary embodiments relate to either of apparatus or to corresponding and/or associated methodology, as will be understood by those of ordinary skill in the art.

One such present exemplary methodology relates to secured inventory management through use of an electronic access control system from a central system via the use of a hub-based control arrangement, for use with securable storage enclosures of the type having at least an exterior portion and a securable interior portion. Such exemplary methodology preferably may comprise providing a microprocessor based access control circuit having a hub output for providing control data for respective locks; interconnecting a connection hub with such hub output, so as to receive control data from the control circuit; providing a plurality of respective electronic locks associated with such connection hub and with respective storage enclosures, such electronic locks configured to be unlocked by such access control circuit via such connection hub; and providing respective control signals to respective associated electronic locks responsive thereto, via a plurality of respective control outputs from the connection hub.

Variations of such methodology may further include providing memory, associated with the access control circuit, for storage of data associated with access control circuit activity and with contents of an associated storage enclosure for reporting on the access activity for an associated storage enclosure.

Others may include providing a plurality of such connection hubs in a daisy-chained configuration, for controlling a plurality of electronic locks respectively associated therewith, all controlled by the access control circuit via such plurality of connection hubs. Still others may further include selectively identifying the position of each respective connection hub in a daisy-chained configuration.

As will be understood from the complete disclosure herewith, other present alternative methodology may further include providing and controlling power to selected of the electronic locks from a plurality of respective battery power sources connected with the respective connection hubs. In some instances, alternative methodology may simply further include selectively providing operational power to the respective locks via the connection hub.

Other exemplary present methodology may further include providing a plurality of communications modules respectively associated with each of the plurality of electronic locks and communicating over a network including connections which are one of hardwired and wireless connections.

Still further variations may further include automatically determining operational characteristics of the electronic locks associated with the hub-based electronic lock access control system. For some such variations, such automatically determining may include automatically determining whether and what specific types of latches are associated with the hub-based electronic lock access control system.

Yet other variations may further include sensing the operation of associated electronic locks; and selectively operating in user-determined modes of operation for simultaneously operating all of the electronic locks associated with the hub-based electronic lock access control system or for individually operating such electronic locks.

Further, various presently disclosed embodiments may involve various combinations and mixtures of hardwired components and programmable components and associated software.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figures, in which:

FIG. 1 is a schematic overview of an existing (Prior Art) system which has the capabilities of controlling two separate electronic latches;

FIG. 2 is a schematic overview of an exemplary embodiment of the presently disclosed hub-based electronic lock system operable in accordance with the presently disclosed subject matter;

FIG. 3 is a schematic overview of a further exemplary embodiment of the presently disclosed hub-based electronic lock system operable in a daisy-chained configuration in accordance with the presently disclosed subject matter;

FIG. 4 is an isometric, generally side and partial top view of an exemplary hub-based electronic lock embodiment, configured with an exemplary electronic latch and associated door switch embodiment, in accordance with the presently disclosed subject matter;

FIGS. 5A and 5B are a generally top perspective view, and an enlarged isolated portion thereof, respectively, of an exemplary hub component for an electronic lock constructed in accordance with the presently disclosed subject matter; and

FIGS. 6 through 16 are representative screenshots, respectively, of various functionalities which may be provided in accordance with exemplary embodiments of the presently disclosed subject matter.

Repeat use of reference characters throughout the present specification and appended drawings is intended to represent same or analogous features, elements, or steps of the presently disclosed subject matter.

### DETAILED DESCRIPTION OF THE PREFERRED EMBODIMENTS

As discussed in the Summary of the Subject Matter section, the presently disclosed subject matter is particularly concerned with improved apparatus and methodology for electronic lock systems and related functionality.

Further, presently disclosed subject matter relates to a programmable electronic lock system having the ability to control a plurality of electronic locks from a central system via the use of a hub-based control arrangement. In one such exemplary embodiment, up to eight electronic locks may be controlled through a single hub-based configuration.

Yet further, a plurality of such hub-based configurations may be arranged in a daisy-chained embodiment for controlling either higher numbers of electronic locks, in accordance with presently disclosed subject matter. For example, per one presently disclosed exemplary embodiment, up to 32 electronic locks may be controlled, arranged in four latching hubs of eight each.

Selected combinations of aspects of the disclosed technology correspond to a plurality of different embodiments of the presently disclosed subject matter. It should be noted that each of the exemplary embodiments presented and discussed herein should not insinuate limitations of the presently disclosed subject matter. Features or steps illustrated or described as part of one embodiment may be used in combination with aspects of another embodiment to yield yet further embodiments. Additionally, certain features may be interchanged with similar devices, features, or steps not expressly mentioned which perform the same or similar function.

Reference will now be made in detail to the presently preferred embodiments of the subject electronic lock and related technology.

A typical standard electronic lock product most frequently secures a single door or drawer. For example, a code may be entered or a validation access card may be presented, either of which once validated, may cause an electronic mechanism to allow the credential-presented (user) to access the secured door or drawer. It is also typical that if there multiple drawers or doors to be secured, there are respectively multiple lock systems. Such multiplicity can contribute to significant costs, complications, and difficulty, particularly when a supervisory level or similar user attempts to manage in such a multiple electronic lock environment. The presently disclosed subject matter enables such a higher level user to manage (control) multiple electronic locks/latches associated with multiple doors or drawers, through the use of a single, integrated electronic lock system.

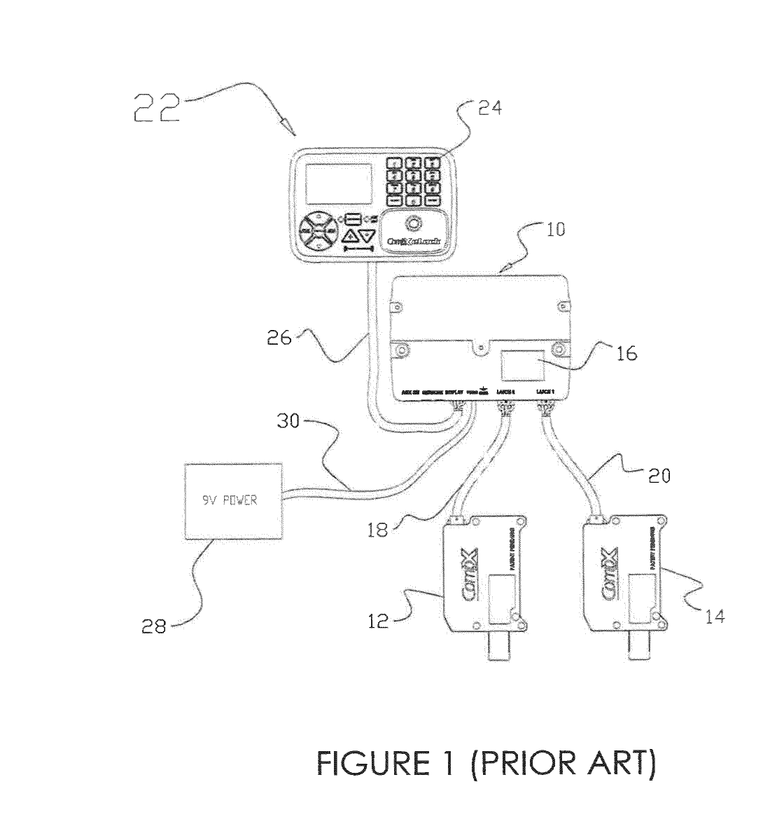

FIG. 1 herewith is a schematic overview of an existing (Prior Art) system having a main control box 10 which has the capability of respectively controlling two separate electronic latches 12 and 14. As noted above, such electronic latches 12 and 14 may comprise devices as represented and disclosed in commonly owned U.S. Pat. No. 8,403,376 or a simple electronically controlled solenoid based latch may be used. As represented in present FIG. 1, such main control box 10 has a port which serves in effect as an expansion port by receiving a circuit board 16 specially configured for handling the two respective latches 12 and 14 as illustrated through the one control box. As shown, each such latch has a representative wired connection 18 and 20 for which a wireless or other connection could be substituted, as well understood by those of ordinary skill in the art. Further, the prior existing control box may be accessed for validation and for control input such as through a display (generally 22) which has a keyboard 24 and/or other input capabilities, as well understood by those of ordinary skill in the art. Such communications may take place through a wired connection 26 or through alternative connections. Still further, as represented by FIG. 1, a power supply 28 (such as a representative 9 Volt power supply) may be connected through wiring 30 for powering such main control box 10, as well as for powering latches 12 and 14 through wiring 18 and 20, respectively.

As illustrated by FIG. 1, prior existing technology permits validated inputs to a control box to be used in turn to respectively manipulate up to two separate electronic latches, using power from a battery source or other power input.

The presently disclosed subject matter, in some embodiments thereof, permits validated control and related functionality (such as activity tracking) for up to 32 electronic locks, operated in groups of eight through a hub-based arrangement driven through a common control box.

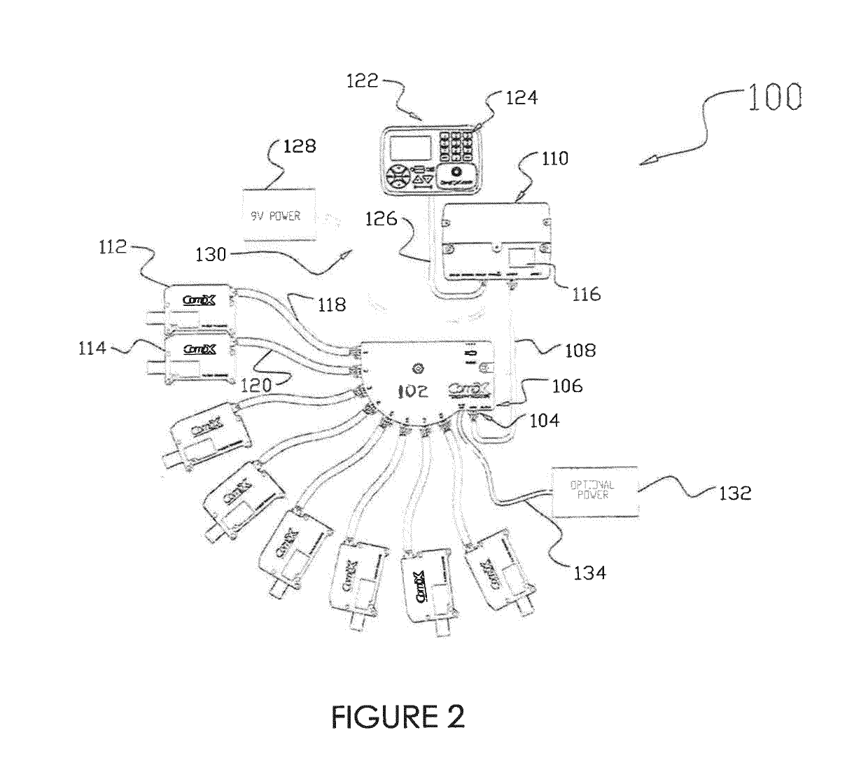

FIG. 2 provides a schematic overview of an exemplary embodiment of the presently disclosed hub-based electronic lock system operable in accordance with the presently disclosed subject matter. In this exemplary embodiment of presently disclosed subject matter, a main control box 110 includes a circuit board 116 in an expansion port thereof. Such circuit board 116, as disclosed herein, amounts to a hub-supporting circuit board. Main control box 110 may have also an associated display 122 such as with keyboard 124 and other inputs as will be well understood by those of ordinary skill in the art.

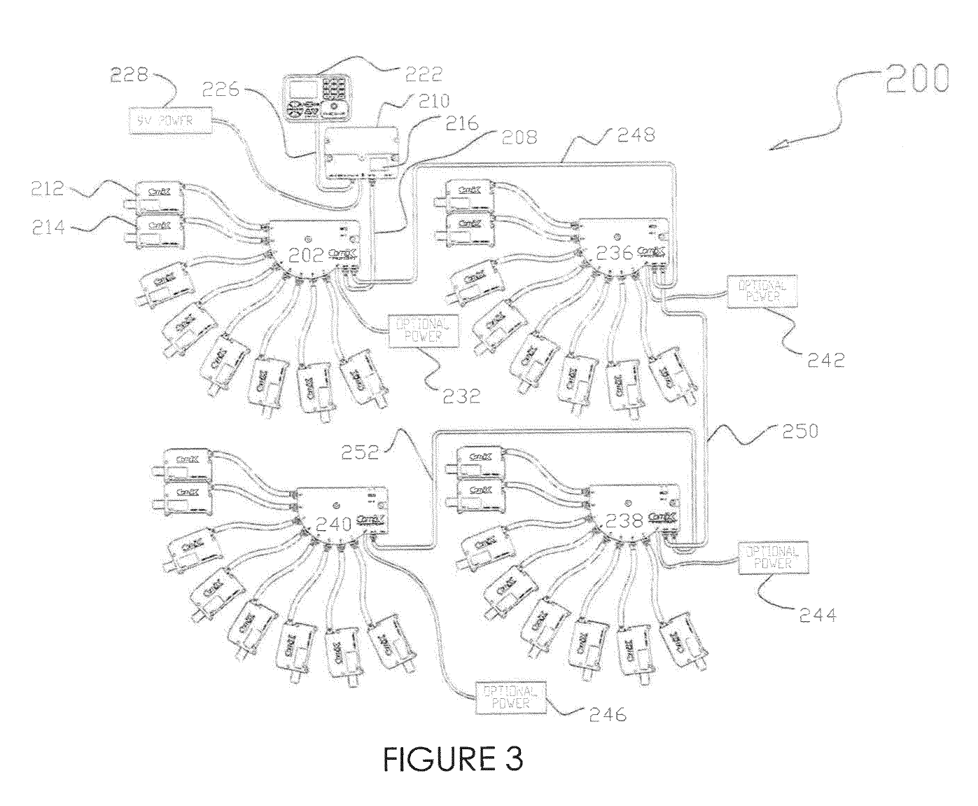

A representative hub 102 is illustrated as having a respective input 104 and output 106. Output 106 constitutes an auxiliary output for use in a daisy-chained configuration, as further discussed herein with reference to application FIG. 3. As illustrated by FIG. 2, main control box 110 may communicate via wiring 108 with the input 104 of hub 102. As represented, exemplary hub 102 in turn has eight electronic lock control outputs, such as respectively associated with representative electronic locks (latches) 112 and 114, which conduct communications and power thereto via respective wirings 118 and 120. Other numbers of associated electronic locks/latches may be practiced in particular embodiments.

Similar to FIG. 1, a power supply 128 (such as a 9 Volt power supply) may be provided and communicative with main control box 110 via wiring 130. Unlike FIG. 1, FIG. 2 represents that a further power source 132, such as a further battery power supply, may be communicative with hub 102 via wiring 134. As understood by those of ordinary skill in the art from the complete disclosure herewith, operation of the hub embodiment 102 as presently disclosed herewith results in distribution of power through hub 102 to the respective latches, configured as illustrated. Such power may be in part or in whole drawn from source 128 or source 132, or other sources, as discussed herein.

In addition to providing control signals and power to the respective electronic locks, it is to be understood that data such as condition or status data may be obtained from such electronic locks and/or from doors or drawers associated respectively therewith.

FIG. 3 provides a schematic overview of a further exemplary embodiment of the presently disclosed hub-based electronic lock system operable in a daisy-chained configuration generally 200 in accordance with the presently disclosed subject matter. In the particular embodiment illustrated, each of four respective hubs can in turn drive up to eight latches, for a total of 32 latches.

The illustrated daisy-chained arranged is specified as follows. A main control box generally 210 is fitted with a circuit board 216 which adapts control box 210 for operation in a successive hub (or daisy-chained) configuration. An output cable or wiring 208 from control box 210 is connected to a control input connection on hub 202, similar to the arrangement of present FIG. 2 and input 104 of hub 102. However, thereafter, via wiring or cable 248, a control output from hub 202 is fed into the control input of the second hub, hub 236. Still further in turn, the output control of second hub 236 is fed via wiring 250 into the control input of the third hub, hub 238. Yet further, the control output of hub 238 is fed via wiring or cable 252 to the control input a fourth hub, hub 240.

Per such daisy-chained configuration, control inputs after validation are passed along from device 222 into main control box 210, and from there are input to selected electronic locks via one of the four respective hubs.

Those of ordinary skill in the art will understand from the complete disclosure herewith that fewer than four hubs may be practiced and/or fewer than eight latches per hub may be practiced, all within the scope of the presently disclosed subject matter. Similarly, different configurations or arrangements and different types of latches may be practiced in various combinations, all of which are intended as being represented by the multiple hub exemplary embodiment of present FIG. 3.

As will also be understood from the complete disclosure herewith, in addition to power supply 228 and optional power 232, as earlier discussed with reference to the single hub embodiment of present FIG. 2 (see power supplies 128 and 132 and their related discussions), further optional power supplies 242, 244, and 246 may be respectively provided in direct association with the second, third, and fourth hubs 236, 238, and 240, respectively. Such power supplies may be operated for selective sharing of power therefrom, as further discussed herein.

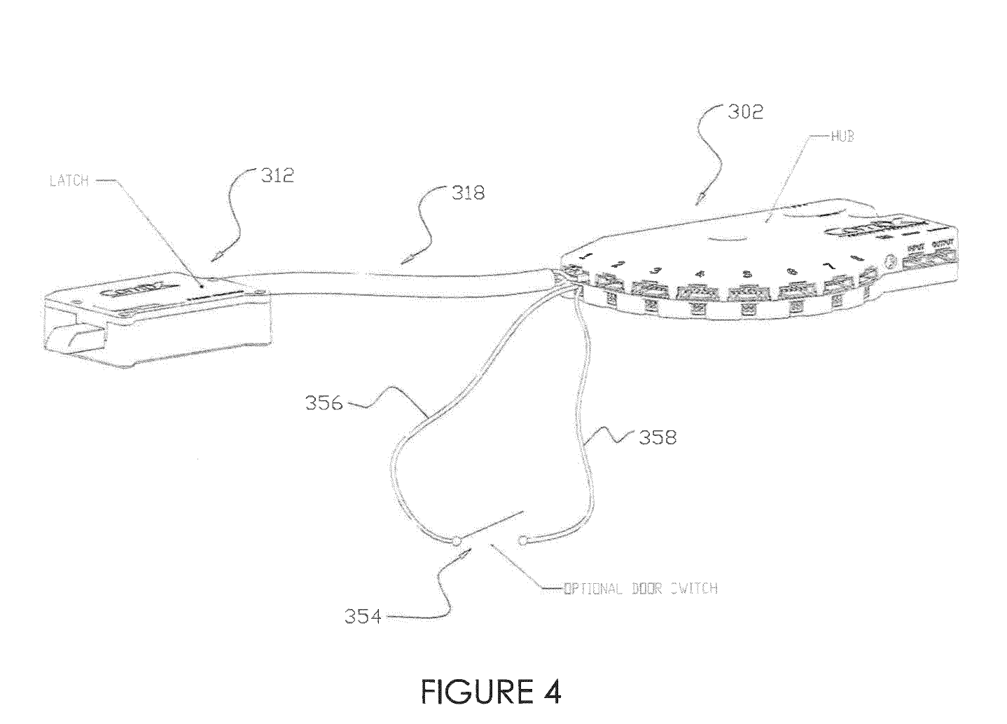

FIG. 4 is an isometric, generally side and partial top view of an exemplary hub-based electronic lock embodiment, configured with an exemplary electronic latch and associated door switch embodiment, in accordance with the presently disclosed subject matter, as may be used with either a single hub or multiple (plural) hub embodiment of the presently disclosed subject matter. As represented, hub generally 302 may be associated with at least one electronic latch 312, with hub 302 and latch 312 communicating via wiring or cable 318. As will be understood, latch 312 is in turn associated with a physical structure to which access is either granted or denied by operation of latch 312 in response to control signals via wiring 318. For example, the associated physical structure may have either of a door or drawer or other structure which may be either opened or closed, for access or denial of access, respectively. If a door, a switch such as representative switch 354 may provide feedback to hub 302 via wiring 356 and 358 regarding whether an associated door is either closed or open. Other forms of feedback or sensors may be implemented, so long as hub 302 obtains data regarding the actual condition (opened or closed) of the structure associated with electronic latch 312.

As will be understood, other such switches 354 or equivalents may be used with each structure associated with an electronic latch associated with hub 302. In particular, as represented by FIG. 4, each position (of representative positions 1 through 8) of hub 302 may provide a connector arrangement suitable for association with wiring or cable 318, and may provide connector(s) arrangement features suitable for use with wiring for an associated switch 354. With such embodiments, any number of the electronic latches associated with hub 302 may each have their own respective feedback switch, for indicating the status (closed or opened) of their respective associated structure (door, drawer, etc.).

Thus, when considering such subject matter on a per hub component basis, while each hub component may control up to 8 latches, it can also monitor up to 8 door switches. Preferably, such door switches may be field installed by the end user to monitor the state (open/closed) of the door that the latch is locking. Such operation may be desired because the state of the latch (locked/unlocked) is not necessarily indicative of the state of the door (open/closed). Thus, such door position switch may be used for multiple purposes, each of which is optional and controllable by the operator. They may include alarming if the door is left ajar for a preset number of minutes, alarming if the door is broken into, as well as email/test/voice/fax if the cabinet is ajar or broken into.

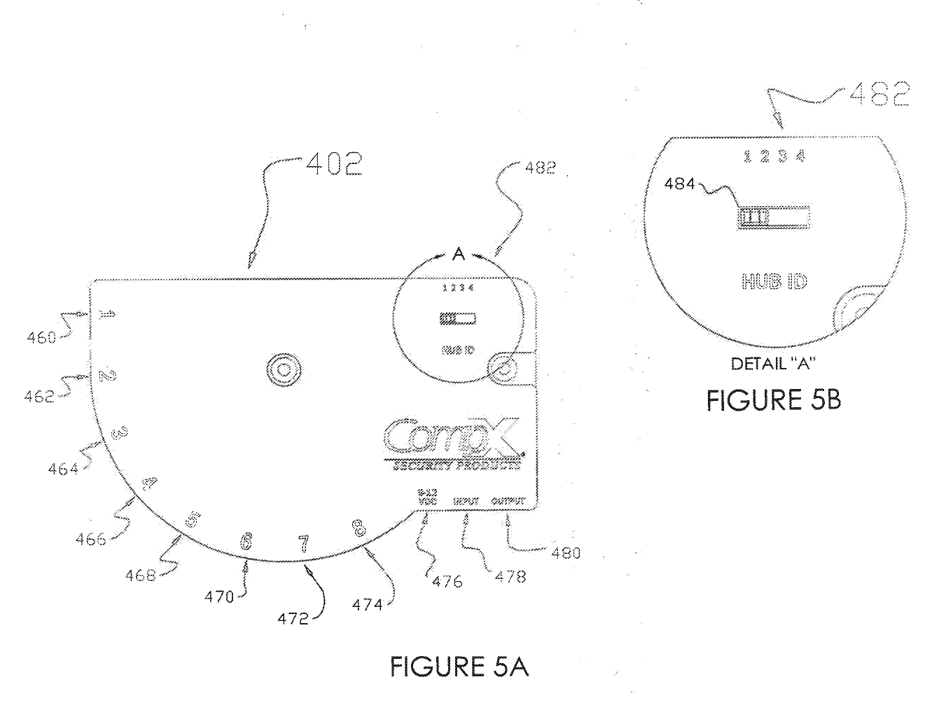

FIG. 5A illustrates a generally top perspective view of an exemplary hub component 402 for an electronic lock system constructed in accordance with the presently disclosed subject matter. FIG. 5B illustrates an enlarged, isolated portion of such exemplary FIG. 5A subject matter.

More specifically, hub 402 may include a variety of connections, per indications 460 through 480. As understood from other disclosure herewith, multiple positions are made available on hub 402 for providing control and power connections and other feedback as discussed herein, and as reflected in part by connection indications 460 through 474, respectively. A power supply, either battery powered or otherwise, may be connected to hub 402 through connector indication 476. As indicated, 9 to 12 Volts would be a nominal input for such connection, useful for powering any of the devices in the overall illustrated components and system. Connector indications 478 and 480 represent input and output portions, respectively, and as otherwise discussed herein.

Further, as represented by present FIG. 5B, a hub identification switch generally 482 may be provided for selection of an identification position of the hub 402, particularly useful in daisy-chained arrangements otherwise described herein. The enlarged, isolated view of FIG. 5B represents that such hub identification switch generally 482 may include a specific switch setting 484 for designating the associated hub as either of hubs 1, 2, 3, or 4 in a given configuration. In other words, such functionality allows the user to configure the hub-based technology in any configuration they choose (for example, 1, 2, 3, 4 or 4, 3, 2, 1 or 1, 3, 2, 4 etc.).

The functionality resulting from the presently disclosed subject matter, whether achieved through hardwired and/or programmed components, may include a number of features. A key point is that, particularly when using a fully implemented, 32 electronic lock daisy-chained configuration, the system collectively will allow full control over all 32 locks/latches from a single input 222 device. The system advantageously automatically determines which latches and what specific types of latches are attached to/associated with the subject electronic lock system. As noted above, each of these latches can either be an electronic latch of the type of commonly owned U.S. Pat. No. 8,403,376 or a simple solenoid based latch. The electronics will know if a latch is connected by the presence/absence, for example, of a resistor on each connector (which will be integral to the interconnect cable). In turn, the size of such resistor may indicate to the electronics whether such an electronic lock or instead a solenoid-based device, or whether nothing is connected. It is also possible to vary the PWM of the solenoid hold voltage to indicate whether larger or smaller solenoids.

Another resulting feature is that once such identification is accomplished, a user will have the ability to assign a name to each respective electronic latch.

Another advantageous feature of the presently disclosed subject matter is that once the electronic locks are configured in a desired system, the user (particularly at the supervisor level) has the ability to select which specific latch to open or whether to open all latches simultaneously. In such context, it may be further established that it is required to meet other conditions (including physical conditions) in order to be able to open all latches simultaneously.

The subject centrally controlled electronic lock system has the ability for an operator or user to assign access rights between a particular user and lock and respectively to each of its sublatches (for example, treating all locks or latches associated with a given hub as being sublatches or sublocks of such hub). Each respective hub has a selectable address so that among the representative four hubs, they may be daisy-chained in any order, using the hub identification switch generally 482 and specific switch setting 484 in order to specify the position (order) of the hubs as desired.

Each latch at each hub also has additional position inputs, as referenced in conjunction with switch 354 of FIG. 4, for enabling position monitoring of the state of an associated door or drawer secured by the respective latch. Particularly where such configuration is practiced in accordance with presently disclosed subject matter, it is possible to store records on detailed audit trail data that the subject hub-based electronic latch system generates. Collectively, the system makes it possible to create and maintain a full audit trail of who opened which latch together with reporting of the optional switch state changes. For example, when reporting whenever each latch opens/closes and when each door switch opens/closes, an audit trail may be generated as represented by Table 1 herewith.

TABLE 1

| Lock | User | Type of | | Alarm | Date of | Time of |
|---|---|---|---|---|---|---|
| Name | Name | Access | Status | Notes | Entry | Entry |
| Hub | admin | N/A | Audit trail | | Aug. 27, 2013 | 2:49:35 PM |
| System | | | viewed | | | |
| | | | Aug. 27, 2013 | | | |
| | | | 2:49PM | | | |
| Hub | N/A | N/A | 26th Latch | | Aug. 27, 2013 | 2:49:12 PM |
| System | | | Latch | | | |
| | | | Closed | | | |
| Hub | N/A | N/A | Latch1 | | Aug. 27, 2013 | 2:49:12 PM |
| System | | | closed. | | | |
| Hub | N/A | N/A | 26th Latch | | Aug. 27, 2013 | 2:49:04 PM |
| System | | | Latch | | | |
| | | | Opened | | | |
| Hub | admin | N/A | Audit trail | | Aug. 27, 2013 | 2:49:19 PM |
| System | | | viewed | | | |
| | | | Aug. 27, 2013 | | | |
| | | | 2:49PM | | | |
| Hub | Mike Card | PROXCARD | Access | | Aug. 27, 2013 | 2:48:56 PM |
| System | New | | granted. | | | |
| Hub | admin | N/A | Audit trail | | Aug. 27, 2013 | 2:48:28 PM |
| System | | | viewed | | | |
| | | | Aug. 27, 2013 | | | |
| | | | 2:48PM | | | |
| Hub | N/A | N/A | Ajar alarm | | Aug. 27, 2013 | 2:48:20 PM |
| System | | | cleared | | | |
| Hub | N/A | N/A | Hub 2 latch | | Aug. 27, 2013 | 2:48:20 PM |
| System | | | five Door | | | |
| | | | Closed | | | |
| Hub | N/A | N/A | Door | Alarm | Aug. 27, 2013 | 2:48:06 PM |
| System | | | Alarm: | | | |
| | | | Ajar; Ajar | | | |
| | | | for 10 | | | |
| | | | seconds | | | |

One aspect of certain presently disclosed exemplary embodiments relates to control of associated power supplies, particularly battery-based power supplies. As will be understood by those of ordinary skill in the art, beyond the powering of electronics of the various electronic lock components disclosed herewith, there are “drive” electronics power needs, chiefly related to operation of the various latches/locks. For example, power is required to drive motors and/or solenoids of such electronic devices.

Power for the overall system may come from the power supply (such as power supply 128 of present FIG. 2) associated with the main control box 110, or from each hub component separately (per the referenced “optional power” devices, such as optional power supply 132 of present FIG. 2).

Preferably, there is a selection behavior embedded in controlling software that allows an operator to choose the mode of operation, for example, all latches operated simultaneously or the selection of one. Per presently disclosed subject matter, if simultaneous action is chosen, each hub component must have its optional power supply connected to facilitate actuation of each latch/lock. Each electronic latch can draw one amp (or more) on start up, and such amount of current requires sufficient (that is, separate) power supplies if more than one latch needs to start simultaneously. The presently disclosed subject matter makes use of slow/staggered starting of associated latch motors if available power becomes limited (such as due to inadequately sized or charged power supplies). The resulting feature may be thought of as specific power management capabilities resulting in latch motor current control improvement.

With reference to such latch motor current control improvement, to maximize the current available to start a latch motor when running from a weak battery or power-limited mains supply, a latch motor control circuit will monitor the input voltage while using pulse width modulation (PWM) to vary the relationship between motor current and supply current. For example, for supply voltages which are close to nominal value, the latch motor will be almost fully “on”. For supply voltages significantly below nominal, the PWM duty cycle will be reduced in such fashion to keep the current drawn from the supply from drawing the supply voltage below half its nominal value. For supply voltages above nominal, the duty cycle will be reduced so as to limit motor currents to approximately what they would be at nominal supply voltage, thus avoiding excess stress on the motor and preventing it from running excessively fast.

As a result of such control methodology, the resulting approach allows good motor performance to be achieved when using a wide variety of power sources including batteries or wall supplies, with all adaptation occurring fully automatically. The latch will operate, slowly, with batteries that would be too weak to drive the latch if it were otherwise switched “full on”. While users of such electronic latch may not particularly like having latch operations under some conditions take as much as five seconds until such time as the battery is replaced, the ability to still operate is far preferable to having the electronic latch simply be unusable.

For the specific exemplary embodiments illustrated herewith, having nominal voltage level inputs of 9 to 12 Volts DC, one example is to control the unit so that it tries to limit the effective latch voltage to about 9 volts. This means that input voltages higher than such selected limit will result in a reduction through desired manipulation of the PWM input control. Because of the maximum amount of power that can be drawn from a 9 volt battery, in order to allow for some operation (albeit at a greatly reduced), the PWM value is controlled to start ramping down, for example, at around 8 Volts but ramps to nearly zero, for example, just below about 5 Volts. It is to be understood that alternative specific operational points may be selected, in order to vary the activity as desired, and all such variations are intended as encompassed by the broader control disclosure herewith.

The following disclosure makes reference to exemplary screenshots of a user's interface with an exemplary embodiment of software for control access to the electronic lock system presently disclosed. In particular, the exemplary screenshots indicate how a user is granted access on a per latch basis with the subject electronic system. It will be understood by those of ordinary skill in the art that appropriate software implementation (in other words, programming) may be undertaken based on the description herewith, which implies various flow chart and/or methodology aspects based on such description and the accompanying Figures.

It is also to be understood that the exemplary embodiment herewith makes use of various identifiers and/or file names which are arbitrarily selected for purposes of this example, as opposed to forming any limitation on the presently disclosed subject matter. In other words, alternative designation names may be selected by those practicing the presently disclosed subject matter to satisfy their own preferences and/or needs, without departing from the spirit and scope of such presently disclosed subject matter.

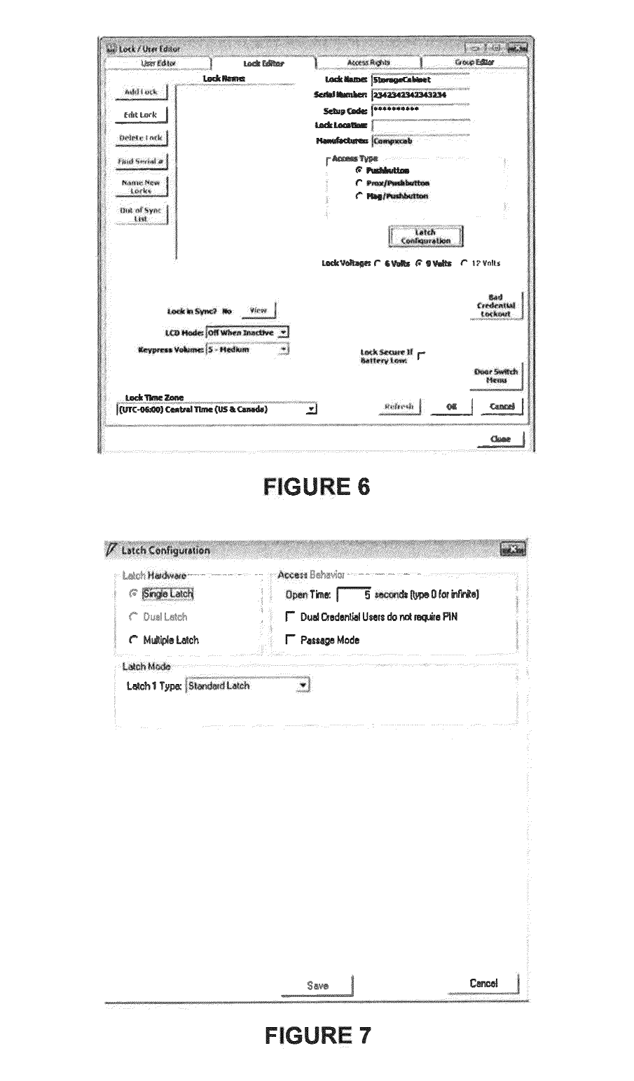

The exemplary screenshot represented by present FIG. 6 illustrates a user's interface with a standard lock editing task. In the particular example hereof, a user is creating a new electronic lock implementation identified as “StorageCabinet.” After selecting the icon “Latch Configuration” of the FIG. 6 screenshot, a user is presented with a screenshot such as represented by present FIG. 7. As shown, selecting “Latch Configuration” enables the user to choose the number of latches. In the indicated example, such activity may involve selecting from single, dual, or multiple.

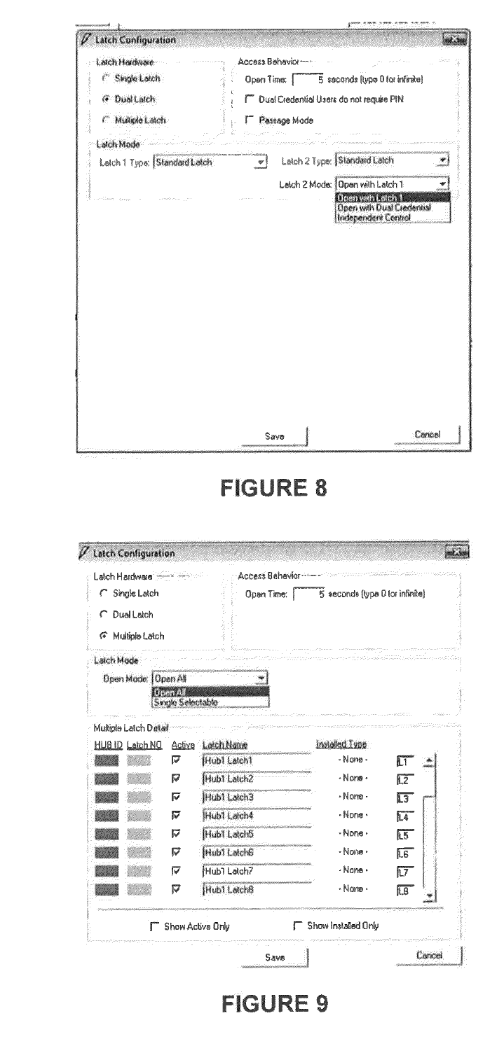

The FIG. 8 exemplary screenshot illustrates that upon choosing the option “Dual Latch,” a user may then choose a mode of operation. In the illustrated example, it is intended that selection of the designation or mode of operation “open with latch 1” means that both latches (of the “dual” latches) will open simultaneously. Selecting the choice “open with dual credential” in the illustrated example (present FIG. 8) means that two respective credentials are required. For example, a designated first latch opens with a first shown credential while a designated second latch opens when a corresponding second credential is shown. Swiping of a debit card followed by entry of a PIN is an example of a dual credential arrangement. In the illustrated example, selection of the mode of operation listed as “independent control” means that reference to both of the dual latches appears in an access rights screen, which enables the operator to respectively grant access to them independently.

Present FIG. 9 illustrates an exemplary screenshot of choices available to a user/operator of a presently disclosed electronic lock system if “Multiple Latch” is selected. In particular, such a selection then permits the operator to choose a mode of operation. As represented by such present FIG. 9, one available selection referenced as “open all” means that all latches that a user has access to will open simultaneously after a valid credential is shown. If instead a mode of operation listed for purposes of present example as “single selectable” is selected, then the subject electronic lock system queries the user to identify which latch to open after a valid credential is shown. Based on control data otherwise loaded into the electronic lock system, the system will only offer as choices those latches for which the user is already cleared for access.

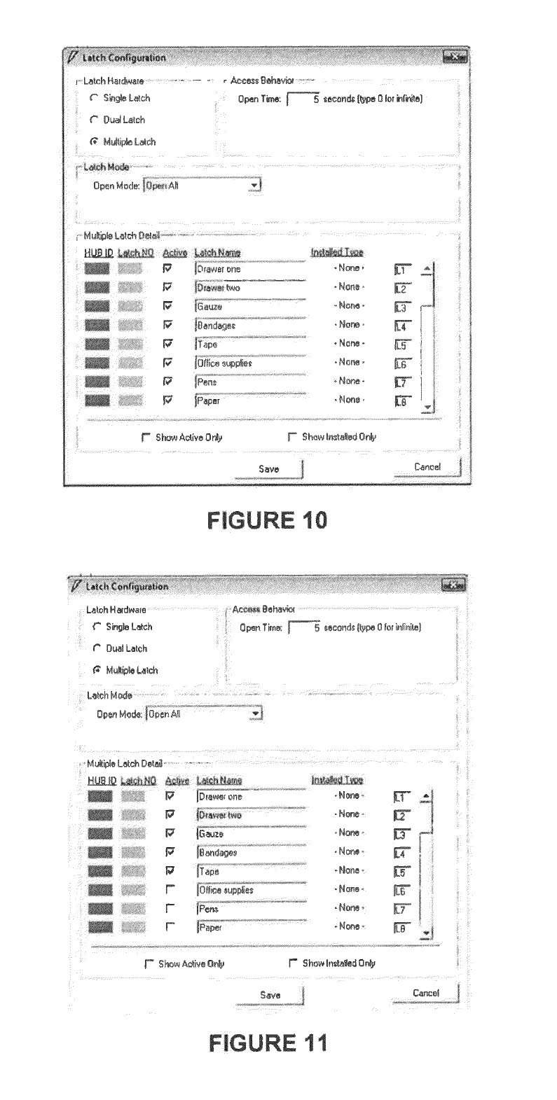

The representative screenshot illustration of present FIG. 9 also shows default latch names, and shows that all latches are default to active. In comparison, present FIG. 10 illustrates in accordance with presently disclosed subject matter a representative screenshot of instances where the operator has changed the names of some of the latches that the designated “StorageCabinet” will control. Some designated names are general (for example, such as drawer one, drawer two, or office supplies) while other designated names are more specific (for example, such as gauze, bandages, tape, pens, paper). All such variations may be selected by the operator or user as desired for a particular implementation of the presently disclosed subject matter, and all such variations are intended as coming within the scope of such presently disclosed subject matter.

The exemplary screenshot of present FIG. 11 illustrates an example by which an authorized operator or user has chosen certain electronic latches associated with a given hub component as being inactive (that is, not active). In the particular example illustrated, latches 6, 7, and 8 are flagged appropriately so as to not be active.

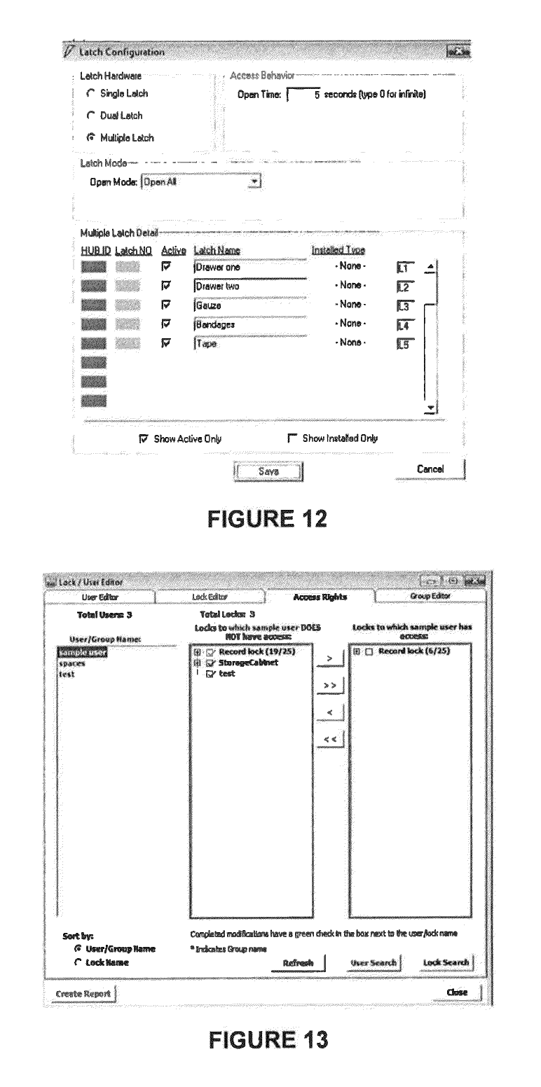

It should also be noted with reference to present FIG. 11 that the operator or user has not selected the option “Show Active Only.” Were such feature activated, then such non-active electronic latches 6, 7, and 8 would not have been shown on the screenshot of present FIG. 11. In fact, the exemplary screenshot of present FIG. 12 illustrates such removal of listings for electronic latches 6, 7, and 8 (based on the exemplary FIG. 11 selections) because the “Show Active Only” display option has been selected. In effect, the inactive latches have disappeared, at least from the screenshot visualizations.

FIG. 13 illustrates a representative exemplary screenshot associated with a presently disclosed drop down feature referenced for example purposes as “Access Rights.” The nomenclature simply reflects that such functionality enables an authorized operator or user to assign access rights for the subject electronic lock system, as between users and the various electronic latches or locks associated with such system.

The FIG. 13 exemplary illustration further represents that an operator or user has selected for viewing the access rights of a designated “sample user.” As shown, such “sample user” does not have access to the electronic lock which has per this example previously been made under the nomenclature “StorageCabinet”. Since there is no “XX/XX” designation next to “StorageCabinet,” it is signified that “sample user” does not have access to all latches controlled pursuant to the grouping “StorageCabinet.”

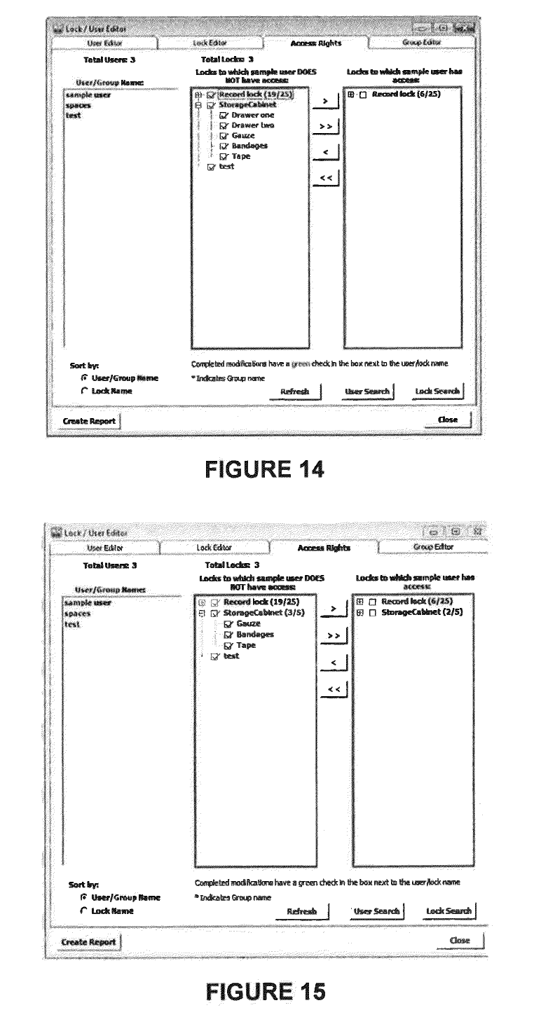

Present FIG. 14 represents a screenshot in those instances where an operator or authorized user has pressed or actuated a designated “+” button next to “StorageCabinet.” In this representative embodiment, such selection results in visual indication of the electronic latches controlled by “StorageCabinet” as such were set up in the electronic lock editor.

Present FIG. 15 representatively illustrates a screenshot whereupon an operator or authorized user has selected features designated as “drawer one” and “drawer two,” which results visually per the presently disclosed subject matter in their movement to the right side of the screen, as a reflection that “sample user” is now provided access to them. For example, note that there now is an indication in the format “(XX/XX)” next to “StorageCabinet” to indicate the number of active electronic locks selected for such user.

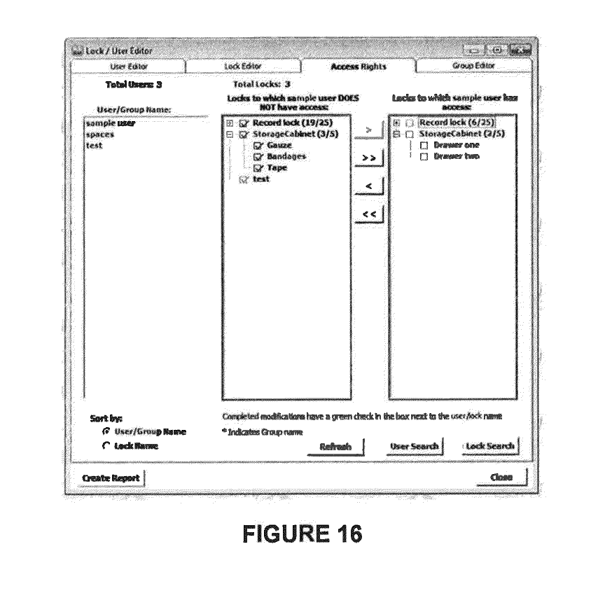

Present FIG. 16 represents an exemplary screenshot as results from an operator or authorized user selecting the “+” button next to the “StorageCabinet” designation in the indicated green box. It may be observed per such exemplary screenshot that “drawer one” and “drawer two” indications are now shown. As a result, it may also be observed that the exemplary entry in the green box reads “StorageCabinet (2/5)”. Such nomenclature is intended to reflect that “sample user” now has access to two of the five latches controlled by “StorageCabinet”.

Per the subject exemplary embodiment, it may also be observed in the middle box portion thereof that it indicates “StorageCabinet (3/5)”. Such nomenclature per the presently disclosed subject matter means that “sample user” does not have access to 3 out of 5 latches controlled by “StorageCabinet.”

While the presently disclosed subject matter has been described in detail with respect to specific embodiments thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations and/or additions to the presently disclosed subject matter as would be readily apparent to one of ordinary skill in the art.

What is claimed is:

1. A hub-based electronic lock access control system for use with a plurality of storage enclosures of the type having respectively at least an exterior portion and a securable interior portion for secure storage, comprising:
a microprocessor based access control circuit having a hub output for providing control data for respective locks;
a connection hub, having an input for receiving control data from said control circuit, and having a plurality of respective control outputs for providing respective control signals to respective associated electronic locks responsive thereto;
a plurality of respective electronic locks associated with said connection hub and respective storage enclosures, said electronic locks configured to be unlocked by said access control circuit via said connection hub; and
memory, associated with said access control circuit, for storage of data associated with access control circuit activity and with contents of an associated storage enclosure.

2. A hub-based electronic lock access control system as in claim 1, wherein said connection hub includes a hub output for providing control signals via said connection hub from said control circuit to another connection hub in a daisy-chained configuration therewith.

3. A hub-based electronic lock access control system as in claim 2, further comprising a plurality of said connection hubs in a daisy-chained configuration, for controlling a plurality of electronic locks respectively associated therewith, all controlled by said access control circuit via said plurality of connection hubs.

4. A hub-based electronic lock access control system as in claim 3, wherein each of said connection hubs respectively includes a hub identification switch for selection of an identification position of the respective hub in a daisy-chained configuration.

5. A hub-based electronic lock access control system as in claim 1, wherein said control circuit controls operational power to said respective locks via said connection hub.

6. A hub-based electronic lock access control system as in claim 1, further comprising:
a user interface configured to provide a user access to said access control circuit through input data verified by said microprocessor;
wherein said access control circuit is configured to unlock said locks based on input data verified by said microprocessor.

7. A hub-based electronic lock access control system as in claim 6, wherein said user interface is further configured to provide a user access to said memory for selective input of preprogrammed codes reflecting either of removal or addition of securely stored contents of the storage enclosures for updating of data in said memory, for coded tracking of stored contents in an enclosure, whereby a user with verified input data can obtain both access control circuit activity data and updated stored contents data from said memory for reporting on a given associated enclosure.

8. A hub-based electronic lock access control system as in claim 7, wherein a user with verified input data can access and name selected of said electronic locks.

9. A hub-based electronic lock access control system as in claim 1, further including a plurality of communications modules respectively associated with each of said plurality of electronic locks and communicating over a network including connections which are one of hardwired and wireless connections.

10. A hub-based electronic lock access control system as in claim 1, wherein said microprocessor based access control circuit and said connection hub respectively have power inputs for connection to respective battery power sources.

11. A hub-based electronic lock access control system as in claim 1, further including:
respective battery power sources connected with said respective connection hubs;
wherein said connection hubs are configured for sharing battery power from said battery power sources, for respectively providing operational power to selected electronic locks being controlled thereby.

12. A hub-based electronic lock access control system as in claim 11, wherein said system is further configured for controlling said respective battery power sources connected with said respective connection hubs, so that the level of operational power from said battery power sources to selected electronic locks is controlled.

13. A hub-based electronic lock access control system as in claim 1, wherein said microprocessor based access control circuit comprises a main control box having a hub-supporting circuit board in an expansion port thereof.

14. A hub-based electronic lock access control system as in claim 1, wherein said microprocessor based access control circuit is configured for determining operational characteristics of the electronic locks associated with the hub-based electronic lock access control system.

15. A hub-based electronic lock access control system as in claim 1, further including at least one sensor associated with at least one of said electronic locks for providing feedback to the associated hub on operation of said associated at least one electronic lock.

16. A hub-based electronic lock access control system as in claim 3, wherein said microprocessor based access control circuit is configured for operation per a user-determined mode of operation for simultaneously operating all of the electronic locks associated with the hub-based electronic lock access control system or for individually operating such electronic locks.

17. A connection hub for use in a hub-based electronic lock access control system for control of a plurality of storage enclosures, said connection hub comprising:
an input for receiving control data thereto from a control circuit;
a plurality of respective control outputs for providing respective control signals to respective associated electronic locks responsive thereto; and
a power input for alternative connection of said connection hub to a battery power source.

18. A connection hub as in claim 17, wherein said connection hub further includes a hub output for providing control signals via said connection hub from the control circuit to another connection hub in a daisy-chained configuration therewith.

19. A connection hub as in claim 18, further comprising a plurality of said connection hubs in a daisy-chained configuration, for controlling a plurality of electronic locks respectively associated therewith, all controlled by an access control circuit via said plurality of connection hubs.

20. A connection hub as in claim 19, wherein each of said connection hubs respectively includes a hub identification switch for selection of an identification position of the respective hub in a daisy-chained configuration.

21. A connection hub as in claim 19, further including:
respective battery power sources connected with each of said respective connection hubs;
wherein said connection hubs are configured for sharing battery power from said battery power sources, for respectively providing operational power to selected electronic locks being controlled thereby.

22. A connection hub as in claim 17, configured for supplying operational power to respective associated locks.

23. A connection hub as in claim 17, further including at least one sensor input thereto, associated with at least one associated electronic lock for providing feedback to said connection hub on operation of such associated at least one electronic lock.

24. Methodology for secured inventory management through use of an electronic access control system from a central system via the use of a hub-based control arrangement, for use with securable storage enclosures of the type having at least an exterior portion and a securable interior portion, comprising:
providing a microprocessor based access control circuit having a hub output for providing control data for respective locks;
interconnecting a connection hub with such hub output, so as to receive control data from the control circuit;
providing a plurality of respective electronic locks associated with said connection hub and with respective storage enclosures, said electronic locks configured to be unlocked by said access control circuit via said connection hub; and
providing respective control signals to respective associated electronic locks responsive thereto, via a plurality of respective control outputs from the connection hub.

25. Methodology as in claim 24, further including providing memory, associated with the access control circuit, for storage of data associated with access control circuit activity and with contents of an associated storage enclosure for reporting on the access activity for an associated storage enclosure.

26. Methodology as in claim 24, including providing a plurality of such connection hubs in a daisy-chained configuration, for controlling a plurality of electronic locks respectively associated therewith, all controlled by the access control circuit via such plurality of connection hubs.

27. Methodology as in claim 26, further including selectively identifying the position of each respective connection hub in a daisy-chained configuration.

28. Methodology as in claim 26, further including providing and controlling power to selected of the electronic locks from a plurality of respective battery power sources connected with the respective connection hubs.

29. Methodology as in claim 24, further including selectively providing operational power to the respective locks via the connection hub.

30. Methodology as in claim 24, further including providing a plurality of communications modules respectively associated with each of the plurality of electronic locks and communicating over a network including connections which are one of hardwired and wireless connections.

31. Methodology as in claim 24, further including automatically determining operational characteristics of the electronic locks associated with the hub-based electronic lock access control system.

32. Methodology as in claim 31, wherein said automatically determining includes automatically determining whether and what specific types of latches are associated with the hub-based electronic lock access control system.

33. Methodology as in claim 24, further including:
sensing the operation of associated electronic locks; and
selectively operating in user-determined modes of operation for simultaneously operating all of the electronic locks associated with the hub-based electronic lock access control system or for individually operating such electronic locks.
